(19) United States
(12) Patent Application Publication
(10) Pub. No.: US 2013/0258272 A1
(43) Pub. Date: Oct. 3, 2013

(54) Lens Covering Device for Treating Amblyopia

(71) Applicant: Rheanna Bristol, LaVerkin, UT (US)

(72) Inventor: Rheanna Bristol, LaVerkin, UT (US)

(21) Appl. No.: 13/852,302

(22) Filed: Mar. 28, 2013

Related U.S. Application Data
(60) Provisional application No. 61/617,624, filed on Mar. 29, 2012.

(51) Int. Cl. G02C 7/16

(52) U.S. Cl. CPC G02C 7/16
USPC 351/158

(57) ABSTRACT

In an embodiment of the present invention, a lens covering device comprises a front segment and a back segment. At least one segment thereof being sufficiently large so as to occlude both frontal and peripheral vision of the dominant eye. The frontal segment being affixed at an upper and lower periphery to the back segment in a manner so as to have at least two opposing openings; one opening on each side of the lens covering device. The at least two openings being of sufficient size so as to allow eyeglass frames to pass through the openings.

### CROSS-REFERENCE TO RELATED APPLICATIONS

This application claims the benefit of U.S. Provisional Application Ser. No. 61/617,624, filed on Mar. 29, 2012, and is incorporated herein by reference.

### BACKGROUND

1. Field of the Invention

The present invention relates to devices for use in the treatment of Amblyopia. More particularly, the present invention relates to a lens covering device for use with eyeglasses.

2. The Relevant Technology

A common problem in the treatment of Amblyopia (also known as “lazy eye”) is not only effectively occluding the vision of the dominant eye, but providing a means for doing so that is aesthetically appealing and easy to put on and take off. Often times the treating physician will use gauze and tape or recommend a pharmacy skin adhesive eye patch as a way of occluding the vision of the dominant eye. However, this is not only difficult to remove and replace, but the patient often feels uncomfortable while wearing the patch. This is especially true for children, who may refuse to wear the patch at all. Another treatment is the use of a lens adhesive sticker that adheres to the outer portion of the lens of eyeglasses. However, this treatment fails to occlude peripheral vision, which lowers the effectiveness of treating Amblyopia.

Several other eye patches exist in the prior art, but all have shortcomings. Some do not preclude peripheral vision, others are tucked too close to the eye, others fail to remain secured in place, some require a nosepiece, and yet others are made of fraying materials that may be dangerous to the eye. The present invention seeks to solve these problems.

### SUMMARY OF EXAMPLE EMBODIMENTS

In an embodiment of the present invention, a lens covering device comprises a front segment and a back segment. At least one segment thereof being sufficiently large so as to occlude both frontal and peripheral vision of the dominant eye. The frontal segment being affixed at an upper and lower periphery to the back segment in a manner so as to have at least two opposing openings; one opening on each side of the lens covering device. The at least two openings being of sufficient size so as to allow eyeglass frames to pass through the openings.

In another embodiment, the lens covering device further comprises a securing device fixedly attached to one of the segments. The securing device comprising a hook, snaps, elastic loops, hook and loops (e.g. Velro®), or other similar devices known to those with skill in the art.

In another embodiment of the present invention, the lens covering comprises a soft, cloth material, such as cotton, that is breathable and can be easily removed and cleaned by a user.

In yet another embodiment of the present invention, the lens covering device may be comprised of colors, shapes, characters, and other designs that appeal to children.

In yet another embodiment of the present invention, a lens covering device may comprise one segment that is folded and fixedly attached at a periphery. The folded segment creating two opposing openings of sufficient size so as to allow eyeglass frames to pass through the openings.

### BRIEF DESCRIPTION OF THE DRAWINGS

FIG. 1 is a perspective view of the lens covering device

FIG. 2 is a perspective top, side-view of the lens covering device in conjunction with eyeglasses

FIG. 3 is a perspective front-view of the lens covering device in conjunction with eyeglasses

FIG. 4 is a perspective rear, user-view of the lens covering device in conjunction with eyeglasses

### DETAILED DESCRIPTION OF EXAMPLE EMBODIMENTS

The following descriptions depict only example embodiments of the invention and are not to be considered limiting of its scope.

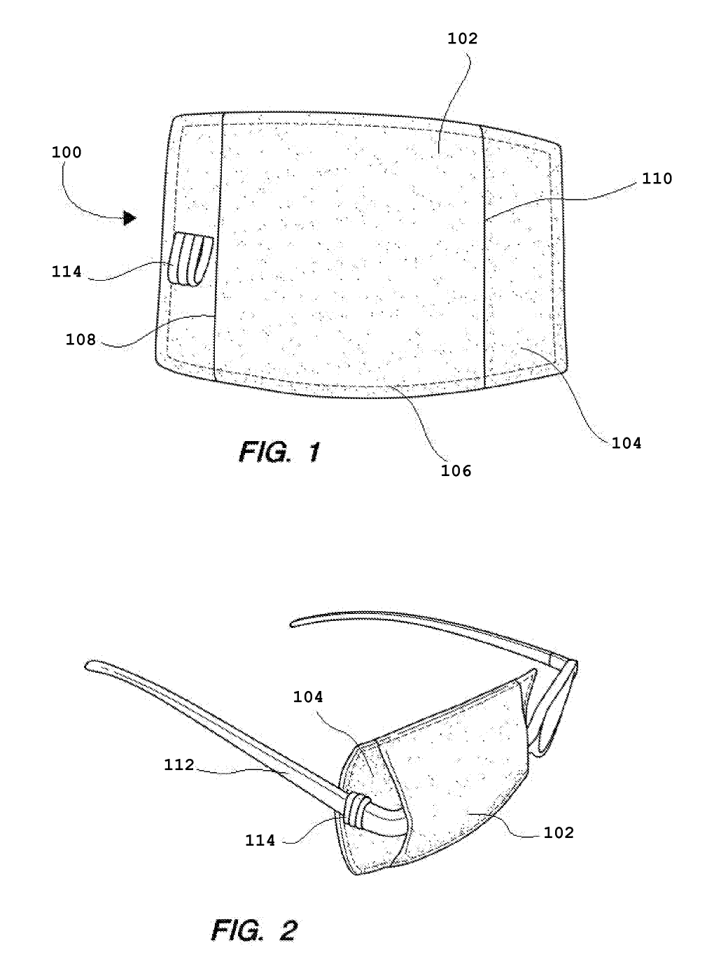

In general, as illustrated in FIG. 1, an embodiment of the proposed invention relates to a lens covering device 100 comprised of a front segment 102 and a back segment 104. While the Figures depict segments 102, 104 as being generally rectangular in shape, it will be appreciated that any shape may be utilized that provides for occlusion of both frontal and peripheral vision. Back segment 104 being sufficiently large so as to occlude both frontal and peripheral vision (as more fully illustrated in FIGS. 2 & 3). While these Figures illustrate back segment 104 as being the segment large enough to occlude peripheral vision, it will be appreciated that the front segment 102 may be the large segment or that the segments 102, 104 may be equal in size while at the same time being sufficiently large enough to occlude both frontal and peripheral vision. The segments 102, 104 are attached at seam 106, creating two openings 108,110. The openings 108, 110 being sized so as to allow eyeglass frames 112 (as shown in FIGS. 2 & 3) to pass there-through. It will be appreciated by those with skill in the art that seam 106 may be permanently affixed or may also be removable by using hook and loop systems (e.g. Velcro®), snaps, or the like.

As further illustrated in FIG. 1, another embodiment of the present invention comprises a securing device 114 that is attached to a segment 102,104 and is removably attachable to the eyeglass frames 112 (as more fully illustrated in FIGS. 2 & 3). The securing device 114 comprising a hook, snaps, elastic loops, or other similar devices known to those with skill in the art. Securing device 114 aids in assuring that lens covering device 100 remains in place so as to effectively occlude both frontal and peripheral vision.

As illustrated in FIG. 2, the lens covering device 100 fits over the eyeglass frames 112 and is secured by securing device 114. The lens covering device 100 is positioned on eyeglass frames 112 so as to occlude both frontal and peripheral vision. Lens covering device 100 makes minimal contact with the eye and/or face because it is held at the distance of the user's eyeglass frame. This reduces irritation on both the eye and face. Lens covering device 100 may also be adjusted by the user and held securely in a desirable place because of securing device 114. This allows a user to adjust the lens covering device 100 to fit various frames and to prevent excessive wear on the bridge of a user's nose.

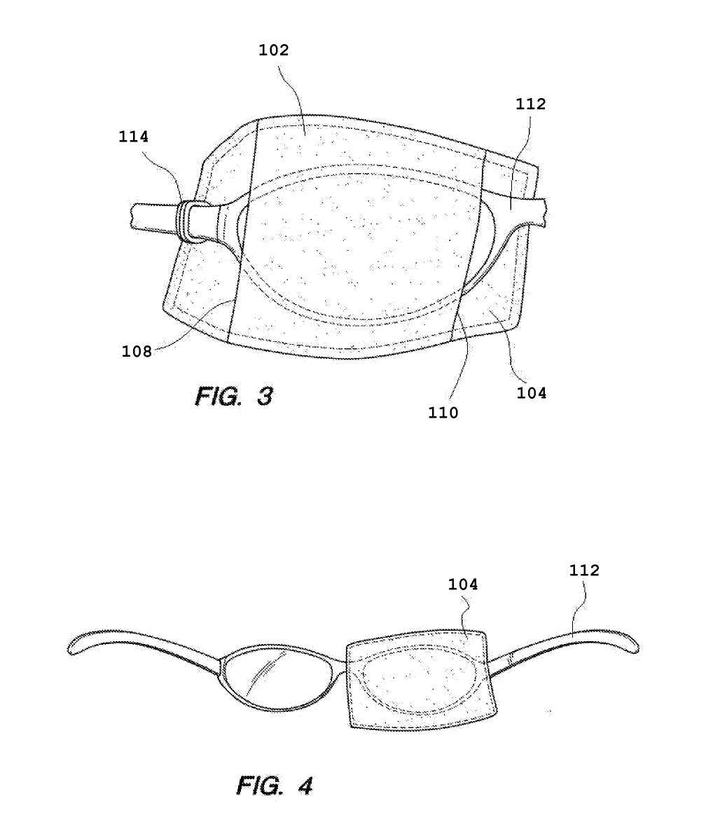

As illustrated in FIG. 3, the eyeglass frames 112 pass through openings 108, 110 so that front segment 102 is positioned so as to cover the front of the lens, while back segment 104 is positioned so as to occlude both frontal and peripheral vision, with securing device 114 engaged to frame 112 to maintain the positioning.

As Illustrated in FIG. 4, the back segment 104 is of sufficient size so as to occlude both frontal and peripheral vision.

In one embodiment, lens covering device 100 comprises a soft, cloth material (e.g. cotton), that is breathable and can be easily removed and cleaned by a user.

In yet another embodiment of the present invention, the lens covering device 100 may also comprise colors, shapes, characters, and other designs that appeal to children. While segments 102,104 are depicted as being rectangular in shape, they may also be other shapes (e.g. heart, diamond, etc.) and/or characters (e.g. Mickey Mouse®, etc.).

In yet another embodiment of the present invention (not illustrated), a lens covering device may comprise a single segment folded and affixed at a periphery, at least two opposing openings, and a securing device.

As referenced herein, the affixing means for segments may comprise snaps, hooks and loops (e.g. Velcro®), stitching (sewn), or any other means known to those of skill in the art.

While the invention has been disclosed with respect to a limited number of embodiments, it will be apparent by those having skill in the art that modifications and adaptations to those embodiments may occur without departing from the scope of the present invention.

What is claimed is:

1. A lens covering device for use with eyeglasses, the lens covering device comprising:
a front segment affixed at the upper and lower periphery to a back segment; and
opposing openings sized so as to receive eyeglass frames.

2. The lens covering device of claim 1 wherein the front and back segments are sized so as to occlude both frontal and peripheral vision.

3. The lens covering device of claim 1 wherein the front and back segments are comprised of cotton.

4. The front and back segments of claim 1 further comprising inanimate shapes or characters.

5. A lens covering device for use with eyeglasses, the lens covering device comprising:
a front segment affixed at the upper and lower periphery to a back segment;
opposing openings sized so as to receive eyeglass frames; and
a securing device.

6. The lens covering device of claim 5 wherein the securing device comprises at least one elastic loop.

7. The lens covering device of claim 5 wherein the securing device comprises at least one hook.

8. The lens covering device of claim 5 wherein the securing device comprises at least one strap with snaps.

9. The lens covering device of claim 5 wherein the front and back segments are sized so as to occlude both frontal and peripheral vision.

10. The front and back segments of claim 5 wherein the front and back segments are comprised of cotton.

11. The front and back segments of claim 5 further comprising inanimate shapes or characters.

12. A lens covering device for use with eyeglasses, the lens covering device comprising:
at least one segment folded and affixed at a periphery;
opposing openings sized so as to receive eyeglass frames; and
a securing device.

13. The lens covering device of claim 12 wherein the securing device comprises an elastic loop.

14. The lens covering device of claim 12 wherein the front and back segments are sized so as to occlude both frontal and peripheral vision.

15. The lens covering device of claim 12, wherein the front segment and back segment comprise cotton.

16. The front and back segments of claim 12 further comprising inanimate shapes or characters.
